(19) United States
(12) Patent Application Publication
(10) Pub. No.: US 2026/0072327 A1
(43) Pub. Date: Mar. 12, 2026

(54) ORBITAL ANGULAR MOMENTUM GENERATION

(71) Applicant: Clemson University Research Foundation, Clemson, SC (US)

(72) Inventors: Eric G. Johnson, Clemson, SC (US); Jerome Keith Miller, Clemson, SC (US); Richard Watkins, Clemson, SC (US); Kunjian Dai, Clemson, SC (US); Justin Free, Clemson, SC (US)

(73) Assignee: Clemson University Research Foundation, Clemson, SC (US)

(21) Appl. No.: 18/318,345

(22) Filed: May 16, 2023

Related U.S. Application Data
(63) Continuation-in-part of application No. 17/838,632, filed on Jun. 13, 2022, now Pat. No. 12,276,896.
Application No. 17/838,632 is a continuation of application No. 16/725,293, filed on Dec. 23, 2019, now Pat. No. 11,402,722.
(60) Provisional application No. 62/784,202, filed on Dec. 21, 2018.
(60) Provisional application No. 63/342,865, filed on May 17, 2022.

(51) Int. Cl. G02F 1/33; H04B 10/27

(52) U.S. Cl. CPC G02F 1/33; H04B 10/27

(57) ABSTRACT

This system is directed to an orbital angular momentum generator which can include an AOD; a beam shaping optic assembly; a log-polar optic; a Fourier lens; and, wherein the orbital angular momentum generator is configured to produce pulse shaping according to the application of a quadratic waveform chirp that corresponds to one or more OAM modes. The system can include an ultrashort pulsed laser; a log-spiral transformation assembly; an AOD; an ellipse generator; a λ/2 plate; and, wherein the optical system is configured to provide for multiple coherent spiral beams with control of amplitude and relative phase. The system can include an ultraviolet orbital angular momentum generator comprising: a femtosecond pulsed laser; a crystal configured to provide a collinear phase-matching; and can provide a UV OAM source for imaging with high resolution and quantum information. The AOD can be replaced with a scanning mirror and configured to add a linear phase gradient.

### RELATED APPLICATIONS

This application claims priority on U.S. Provisional Patent Application 63/342,865 titled Orbital Angular Momentum Generation filed May 17, 2022. This application is also a continuation in part of—and claims priority to—U.S. patent application Ser. No. 17/838,632 titled Tunable Orbital Angular Momentum System filed Jun. 13, 2022, which is a continuation of U.S. patent application Ser. No. 16/725,293 titled Tunable Orbital Angular Momentum System filed on Dec. 23, 2019, which claims benefit of priority to U.S. Provisional Patent Application 62/784,202 entitled Rapidly Tunable Orbital Angular Momentum System for Higher Order Bessel Beams Integrated in Time filed Dec. 21, 2018, all of which are incorporated by reference.

### FEDERALLY SPONSORED RESEARCH AND DEVELOPMENT

This invention was made with government support under MURI Program N00014-20-1-2558, N00014-16-1-3090, N00014-17-1-2779, and N00014-20-1-2037 awarded by the Office of Naval Research. The government has certain rights in the invention.

### BACKGROUND OF THE INVENTION

### 1) Field of the Invention

This invention is directed to the generation of a Bessel-Gaussian (BG) beam and more particularly, ab asymmetric BG beams with the Higher Order Bessel-Gaussian Beams Integrated in Time (HOBBIT) setup using log-polar elements.

### 2) Description of the Related Art

Light beams containing orbital angular momentum (OAM) have been successful in many applications involving structured light for particle manipulation and sensing. Due to the advantage of structured light in these areas, more degrees of freedom are desired in the spatial amplitude and phase. In previous efforts, fan-type beams were demonstrated for particle manipulation by exploiting an azimuthal and radial component of the Poynting vector (e.g., the directional energy flux, energy transfer per unit area per unit time or power flow of an electromagnetic field). A logarithmic ort transform has also been used to enhance the resolution in mode sorting. Although these applications have shown some merit for radial and azimuthal control of the field profiles, much work needs to be done in the areas of unexplored spatial and temporal control for structured light.

The logarithmic spiral can be found in nature and can be seen in galaxies, cyclones, and in the analysis of several natural occurring events. It is also believed that sensing and exploitation of these naturally occurring patterns could result in the advantageous use of structured light for active sensing.

Spirals and rotational motion can be artificially created as well, such as by rotating objects including off axis rotating objects. For example, it can be beneficial to sensing rotating objects such as helicopter blades or propellers of remote operated vehicles, especially in certain defense applications.

OAM beams have been widely used in applications such as optical communication, particle manipulation, quantum information, etc. As a result, the demand for light sources capable of generating high-dimensional OAM is increasing.

In applications that require a certain wavelength, nonlinear light conversion is a useful tool that also conserve OAM in the beam. For example, UV beams usually work as the input in a spontaneous parametric down-conversion (SPDC) to generate entangled photon pairs for quantum imaging. For generation of high-order and high-power UV OAM, having an efficient nonlinear optics method would be advantageous over methods of generating OAM in visible band.

It would be advantageous to have a fast optical system with high efficiency that can be controlled in its spatial dimension for the scaling, rotation, and manipulation of the logarithmic spiral function with temporally controlled OAM at time scales exceeding typical spatial light modulators.

### BRIEF SUMMARY OF THE INVENTION

The above objectives are accomplished by providing an orbital angular momentum generator comprising: an AOD configured to generate a beam having a beam travel path; a beam shaping optic assembly having one or more lens; a log-polar optic having one or more lens; a Fourier lens; and, wherein the orbital angular momentum generator is configured to produce pulse shaping according to the application of a quadratic frequency chirp that corresponds to one or more OAM modes. The system can be an optical system comprising: an ultrashort pulsed laser; a log-spiral transformation assembly; an AOD; an ellipse generator; a λ/2 plate; and, wherein the optical system is configured to provide for multiple coherent spiral beams with control of amplitude and relative phase. The system can be an ultraviolet orbital angular momentum generator comprising: a femtosecond pulsed laser; a type-I Beta Barium Borate crystal configured to provide a collinear phase-matching; and the ultraviolet orbital angular momentum generator is configured to provide a UV OAM source for imaging with high resolution and quantum information. The AOD can be replaced with a scanning mirror and configured to add a linear phase gradient.

The system can be directed to an orbital angular momentum generator comprising and can include a laser source adapted to emit a first beam; an acousto-optic deflector adapted to receive the first beam from the laser source; a frequency generator adapted to apply a waveform, such as a frequency, to the acousto-optic deflector wherein the acousto-optic deflector emits a second beam according to the waveform; and, an optics assembly adapted to receive the second beam, shape the second beam and emit a third beam. The waveform can be a random waveform, or in a preferred embodiment, the waveform may be generated according to a transmission medium. The waveform can include a quadratic chirp. The laser source can be a pulsed laser source and can include a flat wavefront. The laser source can be comprised of multiple laser sources including at least a first laser and a second laser. The orbital angular momentum generator can include a first acousto-optic deflector adapted to receive the waveform or radio frequency and beam and emit a second beam according to the waveform or radio frequency; The second acousto-optic deflector can be adapted to receive the second beam and a second waveform or radio frequency and emit a third beam, and an optics assembly comprised of multiple optics including beam shaping optics, log polar optics, reducing optics, enlarging optics, imaging optics, and any combination thereof, adapted to receive the third beam and shape the third beam to emit a fourth beam.

The optics assembly can include beam shaping optics and a log-polar optics and any combination. The first acousto-optic deflector can be adapted to modify the beam size of a generated asymmetric perfect vortex. The second acousto-optic deflector can be cooperatively associated with the optics assembly to modify the orbital angular momentum of the third beam. The system can include an imaging lens adapted to receive and modify the fourth beam. The first beam can be an elliptical gaussian beam.

The orbital angular momentum generator can include a laser source adapted to provide a first beam; an acousto-optic deflector adapted to receive a radio frequency and the first beam and emit a second beam; and, an optics assembly adapted to shape the second beam to emit a third beam. The first beam can be an elliptical gaussian beam and the third beam can be a spiral beam. The laser source can be an ultrashort pulsed laser and the orbital angular momentum generator can be adapted to provide multiple coherent spiral beams. The laser source can be a femtosecond pulsed laser. The optics assembly can include an optical assembly taken from the group of a beam shaping optics, a log-polar optics and any combination. The acousto-optic deflector can be adapted to include a linear phase gradient into the second beam. A scanning mirror can be disposed between a beam shaping optic and a log-polar optic and adapted to include a linear phase gradient into the second beam. An optics assembly can also be adapted to add a linear phase gradient into the second beam. The scan rate can be equal to or greater than one Khz in one embodiment.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system.

FIG. 2 shows the results obtained by the system.

FIG. 3 shows the results obtained by the system.

FIG. 4 is an illustration of one embodiment of the system.

FIGS. 5A, 5B and 5C are illustrations of one embodiment of the system and results obtained by the system.

FIG. 6 shows the results obtained by the system.

FIG. 7 is an illustration of one embodiment of the system.

FIG. 8 shows the results obtained by the system.

FIG. 9 shows the results obtained by the system.

FIG. 10 is an illustration of one embodiment of the system.

FIG. 11 shows the results obtained by the system.

FIG. 12 is an illustration of one embodiment of the system.

FIG. 13 is an illustration of one embodiment of the system.

FIG. 14 shows the results obtained by the system.

FIG. 15 is an illustration of one embodiment of the system.

### DETAILED DESCRIPTION OF THE INVENTION

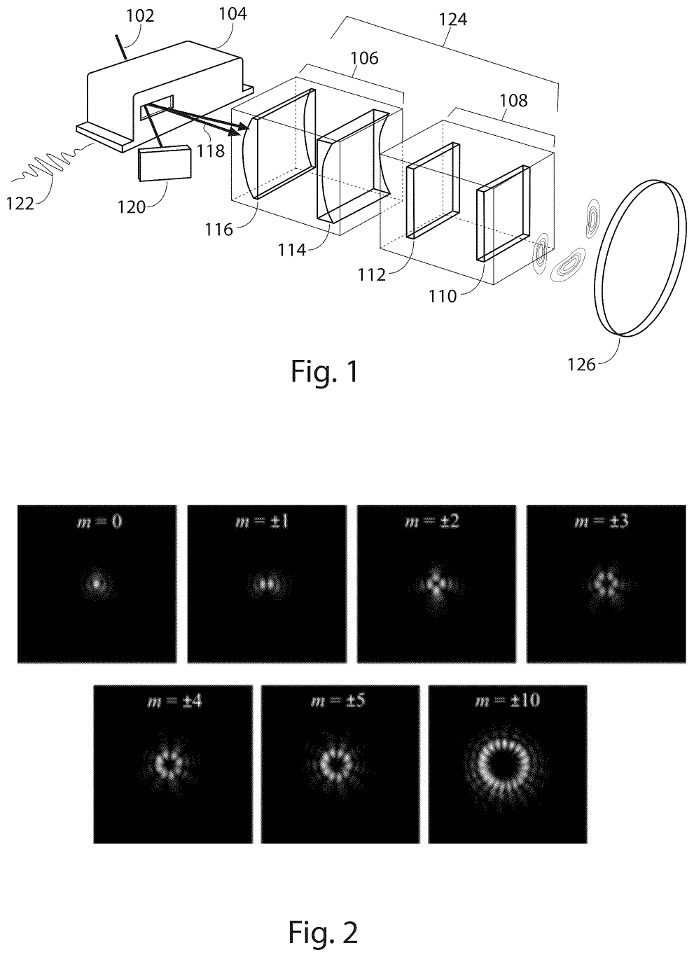

With reference to the drawings, the invention will now be described in more detail. The invention can integrate a laser source in conjunction with the HOBBIT system to emit a beam. The laser source may be comprised of multiple lasers with corresponding beams to include a first laser and a second laser. In one embodiment, the laser source can be a femtosecond laser source at 517 nm with the HOBBIT system. Referring to FIG. 1, the acousto-optic deflector (AOD) 104 and the optics assembly 124, including the beam shaping optics assembly 106, and the log-polar optics assembly 108, that can be included in the HOBBIT system are shown. The AOD 104 may be adapted to receive the beam 102 from a laser source. With the optics assembly 124, the beam shaping optics assembly 106 may consist of one or more beam shaping optics such as 116 and 114. Similarly, the log-polar optics assembly 108 may consist of one or more log polar optics such as 112 and 110. A waveform 122, including a frequency such as a radio frequency, may be created by a frequency generator, including but not limited to radio frequency generators, microwave signal generators, pitch generators, arbitrary waveform generators, and digital pattern generators. The frequency generator may be adapted to apply the waveform 122 to the AOD 104. By applying a waveform signal 122, such as radio frequency or other frequency, to the AOD 104, the AOD 104 receives the laser source beam 102 and emits a second beam 118 according to the waveform 122. The AOD 104 may emit one or more non acousto-optic diffracted beams which may be stopped by the beam block 120. In one embodiment, single or multiple asymmetric BG beams 118 can be generated as shown in FIG. 2. When the optical pulse duration is short (e.g., about 150 femtosecond), the acoustic wave in the AOD 104 appears to be frozen and the interference patterns of the coherent OAM modes can be observed, unlike a continuous-wave (CW) case. In one embodiment, a pulsed laser source is used which can be a single OAM or coherent OAM combinations that can be generated by applying one or more frequencies to the (AOD) 104.

The AOD 104 emits beam 118, a second beam, which can be received by optics assembly 124 which consists of beam shaping optics assembly 106 and log polar optics assembly 108. The beam shaping optics assembly 106 consists of one or more beam shaping optics such as 116 and 114. The log polar optics assembly 108 consists of one or more log polar optics such as 110 and 112. When beam 118 passes through optics assembly 124, and the optics therein 116, 114, 112, and 110, the beam is shaped into another beam, i.e. a third beam. The shape of the beam can be changed by altering the form, order, and shape of the optics assembly 124 and the optics 110, 112, 114, and 116. The beam then enters Fourier lens 126 where an APV beam is Fourier transformed into one or more Higher Order Bessel Gaussian Beams.

It should be understood that this system is not limited to a single waveform or multiple waveforms applied to the AOD. Because this is a pulsed laser source, a window can be applied to the AOD that results in a waveform or frequency chirp across the pulse. A quadratic chirp, for example, can be applied to the AOD where the waveform or frequency is defined by the following representation:

$$f ( t ) = {f}_{0} + β {t}^{2} \qquad ( 1 )$$

where

$$β = \frac{{f}_{1} - {f}_{0}}{{T}^{2}} ,$$

f₀ is the start frequency, f₁ is the end frequency and T is the time it takes to sweep from f₀ to f₁. The phase can be defined by the following representation:

$$φ ( t ) = 2 π ( {f}_{0} t + \frac{β}{3} {t}^{3} ) \qquad ( 2 )$$

and the quadratic chirp signal applied to the AOD can be expressed by the following representation:

$$x ( t ) = sin ( 2 π ( {f}_{0} t + \frac{β}{3} {t}^{3} ) ) \qquad ( 3 )$$

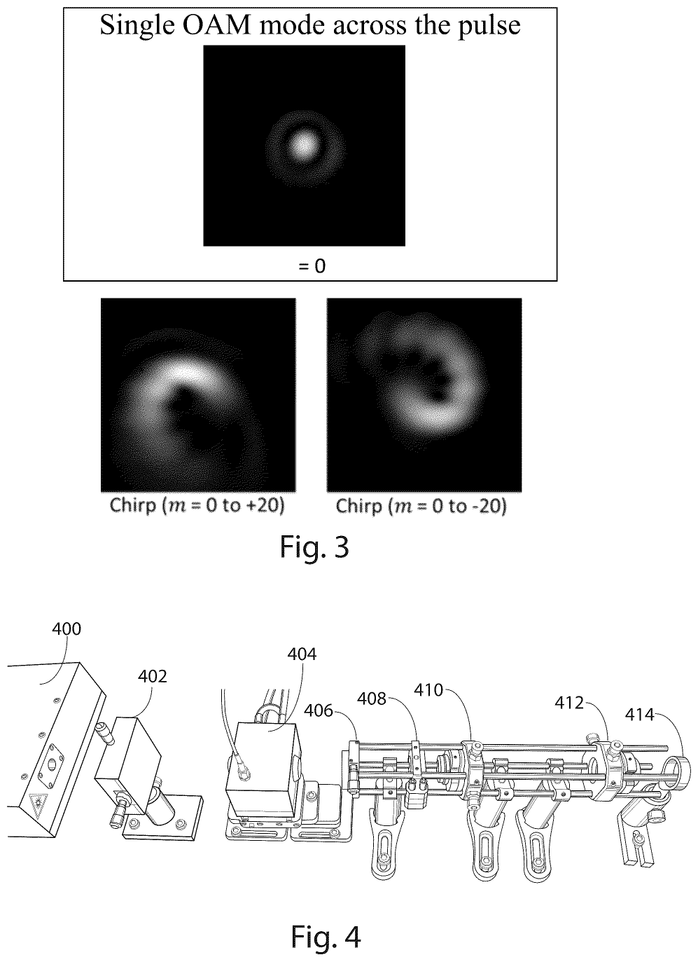

Referring to FIG. 3, a result of applying this quadratic frequency chirp that corresponds to OAM modes m=0 to +20 (left) and m=0 to −20 (right) across the pulse is shown. FIG. 3 shows the pulse shaping of the femtosecond pulse by changing the frequency across the pulse. Pulse shaping can be achieved by varying the frequency, and amplitude, across the pulse.

Referring to FIG. 4, components of the invention are shown. A carbide laser 400 can be used for generating a beam. In an embodiment of the invention, the beam may have a flat wavefront, where generally the wavefront refers to the set of all points having the same phase. A λ/2 waveplate 402 can be configured and disposed to receive the beam generated from the laser. The AOD 404 can receive the resulting beam which can then be transmitted to the optics assembly 406, 408, 410, and 412. The optics assembly may include one or more beam shaping optics 406 and 408 and one or more log-polar optics 410 and 412. Upon passing through the optics assembly, the beam enters the Fourier lens 414 where an APV beam is Fourier transformed into one or more Higher Order Bessel Gaussian Beams. In one example, the wavelength is 515 nm and the light conversion results from a carbide laser (e.g., femtosecond laser) having a variable pulse width in the range of 150 femtosecond (fs) to 20 picoseconds (ps) with a Δτ=150 fs. The pulse repetition frequency can be in the range of 1 kHz to about 100 kHz. In one embodiment, the laser can be a Carbide laser operating from a single shot up to a 2 MHz wavelength.

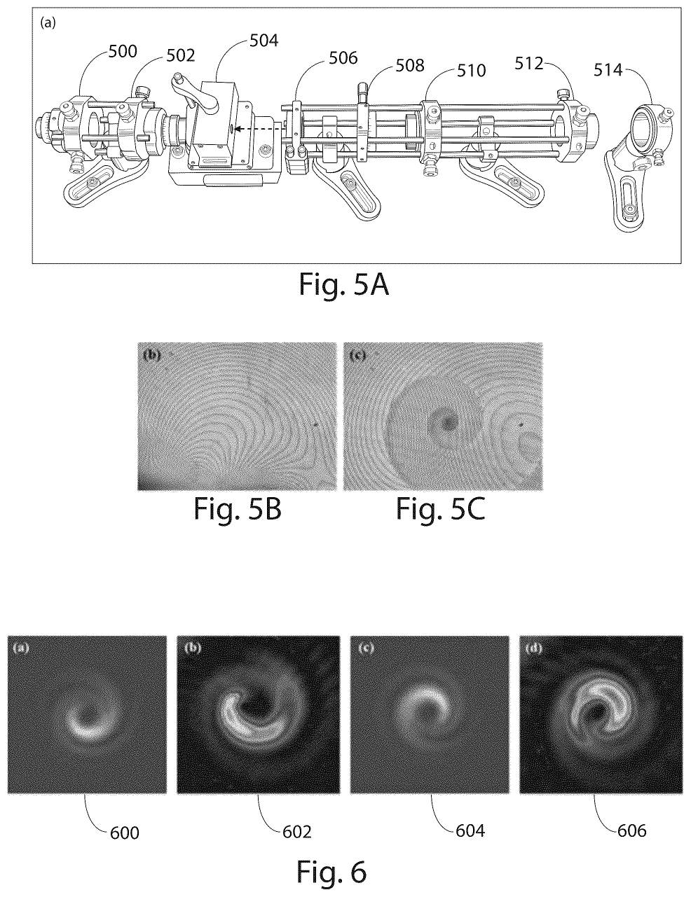

This system can provide an ultrafast optical system with a logarithmic spiral coordinate mapping functions represented by the following:

$$u ( r , θ ) = \frac{β}{1 + {a}^{2}} [ a ln ( \frac{r}{{r}_{0}} ) + θ ] v ( r , θ ) = \frac{β}{1 + {a}^{2}} [ ln ( \frac{r}{{r}_{0}} ) - a θ ] \qquad ( 4 )$$

where a is a constant determining the radius of spirals, β is a constant related to the OAM, r₀ is a scaling constant, rand θ are coordinates in plane two, and u and v are coordinates in plane one. Eq. (1) represents a mapping from a logarithmic spiral in plane two to parallel horizontal lines in plane one. The phase functions required to implement this transform can be solved by the following:

$${Φ}_{1} ( u , v ) = \frac{2 π}{λ f} \frac{{r}_{0} β}{1 + {a}^{2}} exp ( \frac{au + v}{β} ) [ sin ( \frac{u - av}{β} ) + a cos ( \frac{u - av}{β} ) ] - \frac{π}{λ f} ( {u}^{2} + {v}^{2} ) , \\ {Φ}_{2} ( x , y , r , θ ) = \frac{2 π}{λ f} \frac{β}{1 + {a}^{2}} [ ( ax + y ) ln ( \frac{r}{{r}_{0}} ) + ( x - ay ) θ - ( ax + y ) ] - \frac{π}{λ f} ( {x}^{2} + {y}^{2} ) , \qquad ( 5 )$$

where Φ₁ is the phase to map a line to a spiral, β₂ is the correcting phase, f is the distance between the phase functions, and λ is the design wavelength. The design parameters for the log-spiral transform were chosen to be a=6 mm/(2π), #=1.5 mm, r₀=0.75 mm, f=115 mm, and λ=515 nm. The log-spiral optics may be fabricated in fused silica, but other methods of construction are not inconsistent herewith. Images of the possible optics are given in FIG. 5B and FIG. 5C.

Referring to FIG. 5A an embodiment of the invention is depicted along with images of fabricated optics in FIG. 5B and FIG. 5C. FIG. 5A shows a system for generating spiral OAM beams. Fabricated optics for the line to spiral transformation Φ₁ FIG. 5B, and correcting phase Φ₂ FIG. 5C are shown.

A beam enters the system at λ/2 waveplate 514 which flips the polarization of the beam. An elliptical-gaussian beam is created with a combination of spherical and cylindrical lenses 512, 510, and 506 together comprising a beam shaping optic assembly. Within or in conjunction with the beam shaping optic assembly, aperture 508 blocks out non-diffracted beams. The modified beam is then incident on an acousto-optic deflector (AOD) 504, from which a linear phase tilt can be applied by changing the RF frequency on the AOD. A representative equation for the spiral near field is represented by the following:

$${\vec{U}}_{m} ( r , θ , z , t ) = \hat{y} exp ( - \frac{{( \frac{β}{1 + {a}^{2}} )}^{2} {( a ln ( \frac{r}{{r}_{0}} ) + θ )}^{2}}{{σ}_{x}^{2}} - \frac{{( \frac{β}{1 + {a}^{2}} )}^{2} {( ln ( \frac{r}{{r}_{0}} ) - a θ )}^{2}}{{σ}_{y}^{2}} ) exp ( - im ( \frac{1}{1 + {a}^{2}} ) ( a ln ( \frac{r}{{r}_{0}} ) + θ ) - {ik}_{z} z + i 2 π ( {f}_{0} + {f}_{m} ) t ) \qquad ( 6 )$$

where σₓ an α_{y} are related to the dimensions of the input elliptical gaussian beam, m is the topological OAM charge number, f₀ is the optical frequency of the input beam, k_{z} is the wavenumber, and fₘ is the doppler shifted frequency due to the AOD.

Multiple coherent combinations of spiral beams can be realized by applying multiple frequencies to the AOD 504. In a continuous wave system, the interference pattern between modes will beat at a frequency equal to the magnitude of the difference of Doppler frequency shifts between the modes. However, because this system is implemented with an ultrashort pulsed laser, the time-dependent phase shift between two or more OAM modes is eliminated and the relative phase between the modes can be controlled. The beam exiting AOD 504 may be applied to optics comprising an imaging telescope to magnify or compress the image. The beam then enters optics 502 and 500 which are log polar optics that maps the beam into a spiral.

FIG. 5B is a cross section of the log polar optic 502. FIG. 5C is a cross section of the log polar optic 500. The beam is transformed into a corrected spiral beam by the optics represented by FIG. 5B and FIG. 5C.

Referring to FIG. 6, applications of the system are shown which are compared to the simulated far-field distributions for OAM charge m=−3 and m=+3. The intensity of the simulations and application are consistent. FIG. 6 shows simulated 600, 604 and actual 602, 606 far-field distributions for OAM charge m=−3 600, 602 and m=+3 604, 606.

This optical system can control a logarithmic spiral beam profile spatially and temporally with embedded OAM. This system combined with an ultrashort pulsed laser allows for multiple coherent spiral beams with control of amplitude and relative phase. This new functionality can be exploited using the unique combination of geometrical optical transforms and AOD(s) control in both the near and far-field with a high degree of efficiency and at high speed.

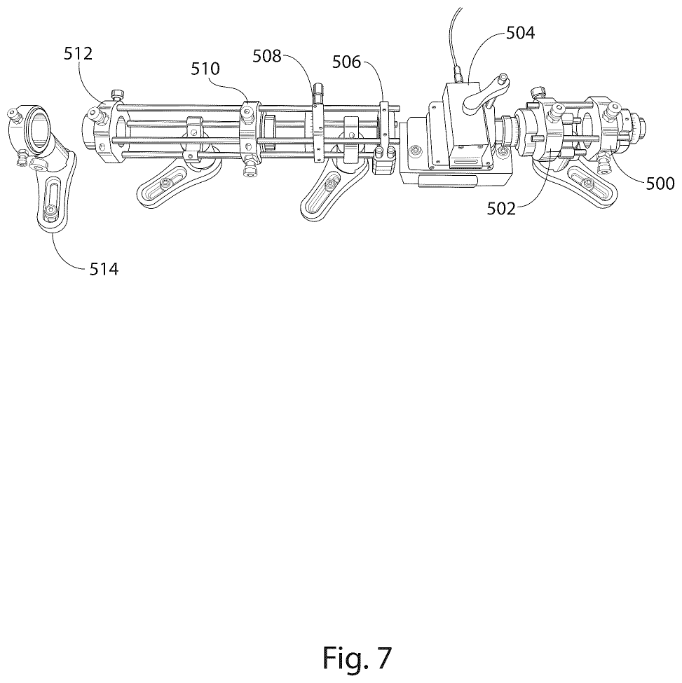

Referring to FIG. 7, a system is shown having a λ/2 waveplate 514 for receiving a beam. The short, pulsed laser can include a 240 fs pulse width, 517 nm wavelength and a 100 kHz repetition rate. Ellipse generation occurs through optics assembly 506, 508, 510, and 512. An AOD 504 is functionally positioned with a log-spiral transformation assembly 500 and 502. The signal that can be applied to the AOD can be represented as:

$$\begin{matrix}s ( t ) = exp ( \frac{{( t - τ )}^{2}}{{σ}_{t}^{2}} ) sin ( 2 π ( {f}_{0} + Δ f ) ( t - τ ) ) & ( 7 ) \\ {k}_{x} \approx \frac{2 πΔ f}{V} & ( 8 )\end{matrix}$$

where the time delay τ rotates the spiral, the frequency Δf controls the tilt angle, f₀ is the center frequency of the AOD and V is the acoustic velocity of the AOD. The OAM in spiral can be represented by the following:

$$- {k}_{x} \frac{β}{1 + {a}^{2}} = \frac{2 πΔ f}{V} \frac{β}{1 + {a}^{2}} \qquad ( 9 )$$

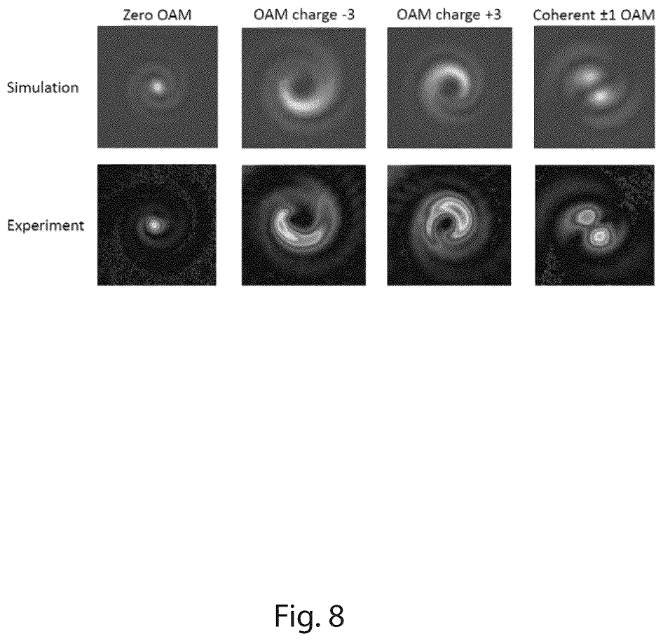

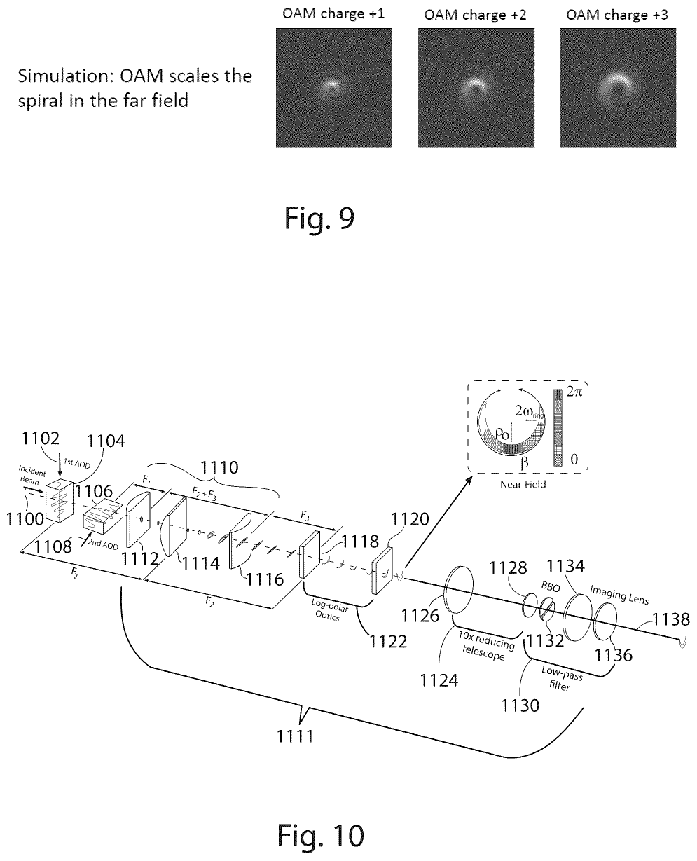

FIG. 8 shows simulated results in comparison with actual results for the various OAM charges. FIG. 9 shows simulated OAM scaling the spiral in the far field.

This embodiment provides for spiral beams generated with dynamic OAM and rotation control. The spiral pulse can be embedded with a different OAM or spiral scale at 100 kHz or greater. There can be a limit to acoustic velocity of AOD and repetition rate of laser. The system can provide a power efficient method for generating spiral beams and can be integrated with an ultra-short pulse laser. The system can be used for particle trapping and manipulation as well as sensing since two-dimensional control of the field can be implemented with a single radio frequency signal at microsecond rates.

In one embodiment, a femtosecond pulsed laser can be used as the fundamental light and can use a 517 nm, a type-I Beta Barium Borate (BBO) crystal using collinear phase-matching as the nonlinear medium and generate high-dimensional OAM beams at 258.5 nm. The specific interference patterns of OAM beams can be utilized to verify the generation of the transformed beam. The system and method can provide UV OAM source for imaging with high resolution and quantum information.

Referring to FIG. 10, the OAM source can be referred to as a 2D HOBBIT system which enables arbitrary OAM mode generation and real-time mode switching. Two items of the HOBBIT are the AOD and log-polar optics. The first AOD 1104 can be used to control the beam size of the generated asymmetric perfect vortex (APV). The first AOD 1104 receives beam 1100 and first waveform 1102 and generates a second beam consistent with said inputs. The second AOD 1106 receives the second beam from the first AOD 1104 and second waveform 1108 and generates a third beam consistent with said inputs. The second AOD 1106 can be configured with the optics assembly 1111 and the beam shaping optics assembly 1110 and log-polar optics assembly 1122 therein to change and control the OAM. The third beam can be shaped by a series of lenses forming an optics assembly shown by 1111, comprising the beam shaping optics assembly 1110 comprising beam shaping optics 1112, 1114, 1116, the log polar optics assembly 1122 comprising log polar optics 1118 and 1120, the telescoping optics assembly 1124 comprising telescopic lenses 1126 and 1128, the magnification optics assembly 1130 comprising optics 1134 and 1136, and crystal 1132. The optics assembly 1111 lenses, optics, and crystals may include beam shaping optics 1112, 1114, 1116, log polar optics 1118, 1120, reducing optics 1126, 1128, enlarging optics 1134 and 1136, crystal 1132, and any combination thereof. The optics assembly 1111 may include an imaging lens system 1110 including one or more cylindrical lenses (1112, 1114, and 1116) which can reshape the beam into another beam. The optics assembly 1111 may include a telescoping assembly 1124 comprising reducing lenses 1126 and 1128 to reduce the beam to focus on crystal 1132. After the beam passes through crystal 1132, it may be subject to the magnification optics assembly comprising 1134 and 1136 to enlarge the now transformed beam 1138. In the embodiment shown in FIG. 10 three cylindrical lenses 1112, 1114, and 1116 are shown for reshaping the beam and two lenses, 1126 and 1128 are shown for re-sizing the beam. Crystal 1132 may be a non-linear optical (NLO) second-harmonic generation (SHG) beta barium borate (BBO) crystal for second-harmonic conversion to halve the fundamental wavelength. By modulating the radio frequency (RF) signals driving the two AODs, control of the APV in both radial and azimuthal directions can be accomplished. An arbitrary combination of sinusoidal waves allows the generation of multiple OAM modes and radial modes. The generated APV can be represented by the following:

$${\vec{U}}_{t} = x exp ( i 2 π ( {f}_{c} + {f}_{ℓ} + {f}_{v} ) t ) exp ( - \frac{{( r - {ρ}_{0} )}^{2}}{{w}_{ring}^{2}} - \frac{{θ}^{2}}{{β}^{2} {π}^{2}} ) exp ( - i ℓθ - {ik}_{z} z ) , \qquad ( 10 )$$

where x stands for horizontal polarization, f_{c} is the frequency of incident light, fₗ and fᵥ is the Doppler frequency shift caused by the two AODs. Parameters ρ₀, w_{ring}, β, k_{z} have the same description as in 11. For nonlinear theory involving single or multiple OAM modes, interaction between modes needs to be considered. Second Harmonic Generation (SHG) takes a wavelength of light and halves the wavelength through a non-linear process. The SHG field can be represented as in Equation 11 when single or multiple OAM are incident.

$${\vec{U}}_{SHG} ∼ {( {\sum }_{ℓ} {\vec{U}}_{ℓ} )}^{2} \qquad ( 11 )$$

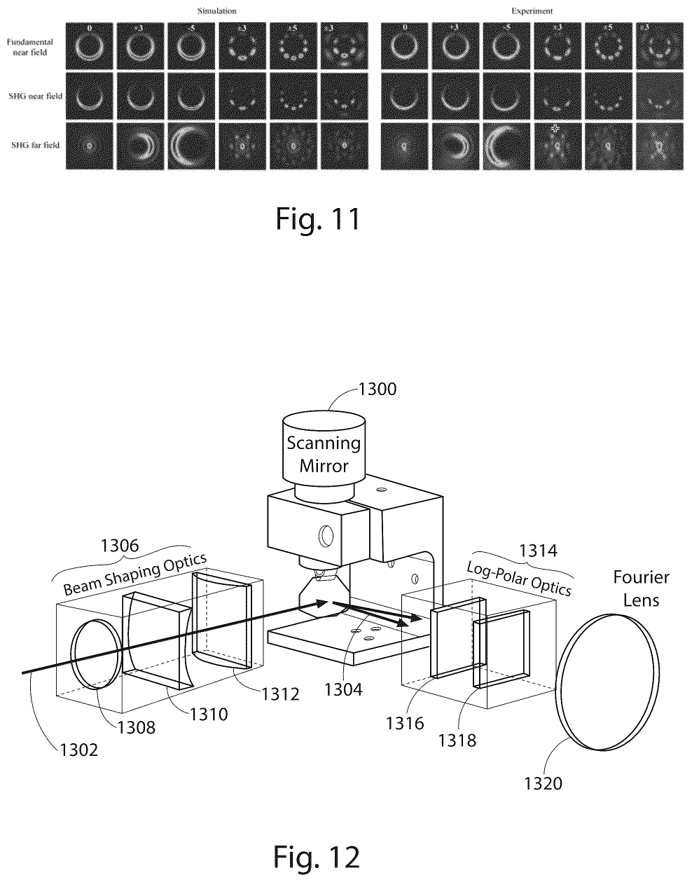

In one embodiment, a femtosecond (e.g., 242 fs) pulsed laser (e.g., Monaco 517) is the light source. A 0.3 mm type-I BBO crystal (e.g., Eksma optics BBO-644H) can be used as the nonlinear medium. A 10× reducing telescope can be used to image the APV to the BBO crystal. The phase-matching condition of the BBO crystal is realized by rotating the crystal in a mount. A 75 mm UV lens can be used to image the generated 258.5 nm APV to the CCD camera. Between the BBO crystal and the UV lens, a low-pass filter (e.g., with a cut-off wavelength at 450 nm) can be used to filter the fundamental light out. The simulation and experimental results are shown in FIG. 11. The simulation is based on Equation 11. The fundamental and SHG APV are given to show the comparison. Since the SHG near field is imaged on the camera, both the fundamental and SHG APV have similar intensity distribution. However, the SHG fields carry a more complicated phase structure which can be verified in the far-field. Because the nonlinear process is intensity related, the SHG APV has more asymmetry. The intensity structure of the SHG far-field is used to verify the OAM interaction in the SHG process. For single OAM, the generated OAM charge is doubled. For multiple OAM, the nonlinear interaction is complicated and can be explained by multiple OAM interaction theory.

The system can provide UV OAM generation through a SHG nonlinear process by using the 2D HOBBIT system as the OAM source and a BBO crystal as the nonlinear medium. Due to the 2D HOBBIT system, high-dimensional OAM beams can be manipulated in radial and azimuthal directions. Single and multiple OAM interactions shows predicted beam generation. The high-dimensional UV OAM source is a useful tool with potential for applications like high-resolution imaging and quantum information processing.

In one embodiment, the beam from the laser source entering the AOD may be an elliptical gaussian beam. Said beam may be modified or adapted as described elsewhere herein.

Referring to FIG. 12, in one embodiment, a scanning mirror 1300 can be used as shown. As discussed above, the HOBBIT system can include an AOD as a component. The AOD can be used to add a linear phase gradient to a Gaussian input beam before the geometric log-polar coordinate mapping which results in an asymmetric ring with azimuthal OAM phase. In some cases, this configuration can be polarization sensitive. This polarization sensitivity can be reduced or eliminated by the implementation of a scanning mirror design. In the scanning mirror design, the scanning mirror 1300 replaces the AOD for adding the linear phase gradient (e.g., linear deflection of a beam in a directed direction). The linear phase gradient may also be added with an optics assembly. The voltage applied to the scanning mirror is proportional to the linear tilt that is applied to the optical beam and therefore is related to the output OAM mode.

In the scanning mirror design, a beam 1302, previously shaped or otherwise, is received by a first optics assembly 1306 and is shaped by one or more optics such as 1308, 1310, and 1312. The beam as emitted by the first optics assembly 1306 is then received by the scanning mirror 1300 which deflects outward beams 1304 to the second optics assembly 1314 with one or more optics such as 1316 and 1318. As the scanning mirror 1300 is rotating, the angle and speed of rotation affects the beams 1304 which are deflected from the scanning mirror 1300. The beam 1304 passes through optics assembly 1314 and exits as a modified beam to Fourier lens 1320 where the modified beam is Fourier transformed into one or more Higher Order Bessel Gaussian Beams. In one embodiment, the modified beam can be an APV beam. The optic assemblies 1306 and 1314 can be beam shaping optic assemblies, log polar optic assemblies, or any combination thereof.

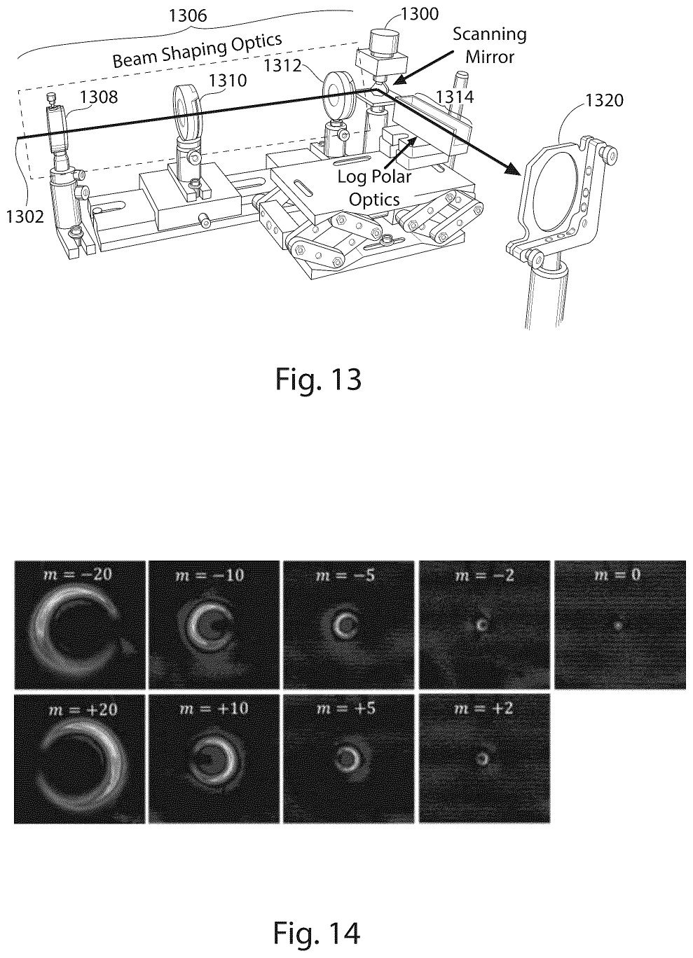

Referring to FIG. 13, In one embodiment lenses used to shape the beam can be a 100 mm (spherical lens) 1308, a 20 mm (cylindrical lens—vertical direction) 1310 and a 200 mm (cylindrical lens—horizontal direction) 1312. The initial Gaussian beam diameter before the beam shaping optics can be 4.8 mm. In such embodiment, after the beam shaping optics and before hitting the scanning mirror 1300 the beam size is 9.6 mm×0.96 mm. This elliptical Gaussian beam is then wrapped to a ring with the log-polar optics 1314 that are designed for λ=1908 nm and have the design parameters of a=14 mm/2π and b=6 mm. With this current design, a change in OAM charge number by 1 unit (Δm=1) is produced by applying a voltage of 3.9 mV to the scanning mirror 1300. The scanning mirror 1300 has a small angle range of ±0.2°. This angle range results in an OAM range of m=+25. The angle and therefore the OAM can be changed at a rate from DC to 1 kHz.

Referring to FIG. 14, possible output of this scanning mirror HOBBIT system is shown. These images were collected by applying a DC voltage to the scanning mirror that corresponds to the appropriate OAM mode. In addition, an AC voltage can be applied to the scanning mirror that results in a time varying OAM output.

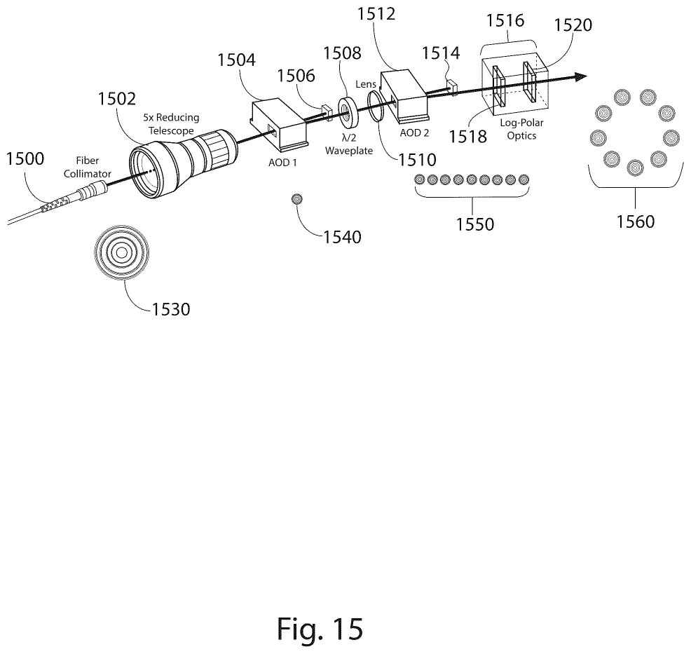

Referring to FIG. 15, the beam source into the HOBBIT system is fiber collimator 1500. The beam leaves fiber collimator 1500 passing into reducing telescope 1502 which uses a series of lenses to reduce the beam. The beam then exits reducing telescope 1502 and passes to first AOD 1504 where the beam is diffracted. Non diffracted beams exiting first AOD 1504 are stopped at first block 1506 while the diffracted beams pass through λ/2 waveplate 1508 which flips the polarization of the beam. The beam then passes through Fourier lens 1508 which Fourier transforms the beam into one or more Higher Order Bessel Gaussian Beams. The transformed beams are then received by second AOD 1512 where the beam is again diffracted. Non diffracted beams exiting second AOD 1512 are stopped by a second block 1514 while the diffracted beams pass through log polar optics assembly 1516. Log polar optics assembly 1516 may be comprised of log polar optics 1518 and 1520 which wrap the beam into a spiral before it exits the Hobbit System. 1530 is a cross section of the beam exiting fiber collimator 1500 and entering the Hobbit system. 1540 is a cross section of the beam after passing through reducing telescope 1502. 1550 is a cross section of the beam after passing through Fourier lens 1510 and being transformed into an array of spots. 1560 is a cross section of the beam exiting the HOBBIT System.

In one embodiment of this scanning mirror HOBBIT design, the system has a scan rate in the kHz range or greater, is polarization independent and results in a total system efficiency of ˜90% with AR coated optics. This system is capable of handling high power that is only limited by the damage threshold of the protected silver mirror that comprises the scanning mirror. This system is capable of time varying OAM generation. This system can have applications in the field of laser machining and laser welding.

In one embodiment, the frequency can be represented by a general polynomial in time that can be represented by the following:

$$\begin{matrix}f ( t ) = a 0 + a 1 * t + a 2 * {t}^{2} + a 3 * {t}^{3} + ⋯ an * {t}^{n} & ( 13 ) \\ {\sum }_{i = 0}^{n} ai * {t}^{i} & ( 14 )\end{matrix}$$

The medium in which one or more of the generated beams can travel can have varying degrees of scattering. The medium, such as air or water, can result in scattering due to any number of particles or structures that redirect the direction of the light. Scattering can include Rayleigh scattering, Mie scattering, and non-selective scattering and the like. The system can use a waveform generated by a frequency generator and applied to the acousto-optic deflector where the waveform is selected according to the transmission medium, i.e. the substance or material through which the waveform passes. The waveform may be selected randomly without regard to other parameters of the system. In some applications such as communications, this deflection can lead to large signal fades since the beam deflection shifts the beam from the detector active area. The system can mitigate the degradation directing and/or redirecting beamlets and modifying their relative phase at the receive aperture.

In one embodiment, two acousto-optic deflectors can be used where a first AOD can control the azimuthal position or rotation angle of the probing beam and a second AOD can controls the phase tilt. The beam that exits this arrangement can be expressed by the following:

$$E ( r , θ ) = exp ( - \frac{{( r - {ρ}_{0} )}^{2}}{{ρ}_{0}^{2} {w}^{2}} - \frac{{( θ - {θ}_{0} )}^{2}}{{w}^{2}} - j ( ( m θ + 2 π ( {f}_{c} + {f}_{A 1} + {f}_{A 2} ) t ) ) ) \qquad ( 15 )$$

where ρ₀=Bexp(−y₀/A)=1.75 mm is the probing radius, w=σ/A=0.24 is the 1/e² angular beam width of the individual Gaussian spot, θ₀ (Δf₁λF)/(AV) is the rotation angle which depends on the applied frequency to the first AOD, f_{A1}, and m=2πAΔf₂/V is the topological charge number of the field which depends on the applied frequency to the second AOD, f_{A2}. Δf₁ is the difference between the center frequency and the frequency applied to the first AOD. Δf₂ is the difference between the center frequency and the frequency applied to the second AOD.

The frequency of the light propagating through the AOD is f_{c}, when λ is 532 nm. Fis the focal length of the lens (150 mm), A and B are the log-polar parameters, and V is the acoustic velocity of the AODs (650 m/s). This system can provide for a Gaussian beam of width pow shifted by the probing radius with tunable rotation angle θ₀ and tunable OAM. Using the system, an arbitrary phase profile for an integer OAM charge can be applied to the beam, which results in a phase gradient tangential to the vortex profile. The rapid switching of the first and second AOD allows for the creation of a phase tilt. With sufficient azimuthal resolution, the discrete Gaussian spots overlap, creating an effectively continuous probing space.

A control system can be used to apply the waveform, such as a radio frequency, signals to the AODs to move the beam through the probing space. In one embodiment, the probing sequence can be limited to 256 waveforms and the probing space set to 35 rotation angles about the ring and 7 OAM phase profiles. In such embodiment the OAM phase profiles allow a step of 5 OAM during the scanning. The normalized OAM spectrum of the beams generated can be represented by exp (−w²/2^{(n+m)}^{²}), where n is the mode index and m is the global OAM of the beam. When w=0.24, the 1/e² width of this spectrum is 16.7, and the step size of 5 OAM enables sampling at less than half of the width of the OAM spectrum. The probing sequence can be started at OAM charge −15 and −2.67 rad from the bottom of the APV forming the ring. The beam can then be stepped by increments of 0.157 radians to 2.67 rad. The Beam is then reset to −2.67 rad before the OAM is changed. Next, the OAM is stepped by 5, and the position scan is repeated. This process continues up to the maximal OAM charge of 15 in this example. Each of the beam states can be held for 615 ns, for a total probe time of 151 ps. While the parameters in this sequence may be changed according to the task at hand, the switching rate is limited by the Gaussian beam diameter over the acoustic velocity of the AOD TeO2 crystal. Changing beam states requires a new acoustic frequency to fully propagate across the input beam.

One of the benefits of this system is the ability to send multiple Gaussian beams at once, each with a different azimuthal position and phase tilt. The system can create multiple distinct Gaussian spots, which can be directed into multiple separate channels. By multiplexing these, the bandwidth of the system for a communication link can be increased. Additionally, increasing the OAM probing range from ±15 to ±30 can result in multiple channels existing simultaneously for r₀=3.8 mm.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. An orbital angular momentum generator comprising
a laser source adapted to emit a first beam;
an acousto-optic deflector adapted to receive the first beam from the laser source;
a frequency generator adapted to apply a waveform to the acousto-optic deflector wherein the acousto-optic deflector emits a second beam according to waveform; and,
an optics assembly adapted to receive the second beam, shape the second beam and emit a third beam.

2. The orbital angular momentum generator of claim 1 wherein the waveform is a random waveform.

3. The orbital angular momentum generator of claim 1 wherein the waveform is generated according to a transmission medium.

4. The orbital angular momentum generator of claim 1 wherein the waveform includes a quadratic chirp.

5. The orbital angular momentum generator of claim 1 wherein the laser source is a pulsed laser source.

6. The orbital angular momentum generator of claim 1 wherein the first beam has a flat wavefront.

7. The orbital angular momentum generator of claim 1 wherein the laser source includes a first laser and a second laser.

8. An orbital angular momentum generator comprising:
a laser source adapted to provide a first beam;
a radio frequency generator adapted to emit a radio frequency;
a first acousto-optic deflector adapted to receive the radio frequency and the first beam and emit a second beam according to the radio frequency;
a second acousto-optic deflector adapted to receive the second beam and emit a third beam, and,
an optics assembly adapted to receive the third beam and shape the third beam to emit a fourth beam.

9. The orbital angular momentum generator of claim 8 wherein the optics assembly includes beam shaping optics, log-polar optics and any combination.

10. The orbital angular momentum generator of claim 8 wherein the first acousto-optic deflector is adapted to modify a beam size of a generated asymmetric perfect vortex.

11. The orbital angular momentum generator of claim 8 wherein the second acousto-optic deflector is cooperatively associated with the optics assembly to modify an orbital angular momentum of the third beam.

12. The orbital angular momentum generator of claim 8 including an imaging lens adapted to receive and modify the fourth beam.

13. The orbital angular momentum generator of claim 8 wherein the first beam is an elliptical gaussian beam.

14. An orbital angular momentum generator comprising
a laser source adapted to provide a first beam;
an acousto-optic deflector adapted to receive a radio frequency and the first beam and emit a second beam;
a first optics assembly adapted to shape the second beam to emit a third beam; and,
a scanning mirror adapted to direct the third beam to a second optics assembly adapted to shape the third beam and emit a fourth beam.

15. The orbital angular momentum generator of claim 14 wherein the second optics assembly is a log polar optic assembly.

16. The orbital angular momentum generator of claim 14 wherein the first beam is an elliptical beam.

17. The orbital angular momentum generator of claim 14 wherein the laser source is an ultrashort pulsed laser, and the orbital angular momentum generator is adapted to provide multiple coherent spiral beams.

18. The orbital angular momentum generator of claim 14 wherein the acousto-optic deflector is adapted to include a linear phase gradient into the second beam.

19. The orbital angular momentum generator of claim 14 wherein the first optics assembly is adapted to include a linear phase gradient into the second beam.

20. The orbital angular momentum generator of claim 14 wherein a scan rate associated with the scanning mirror is equal to or greater than one Khz.
